(19) United States
(12) Patent Application Publication
(10) Pub. No.: US 2016/0219240 A1
(43) Pub. Date: Jul. 28, 2016

(54) Transmitting Apparatus, Receiving Apparatus, Transmitting Method and Receiving Method

(71) Applicants: TOSHIBA LIFESTYLE PRODUCTS & SERVICES CORPORATION, Tokyo (JP); KABUSHIKI KAISHA TOSHIBA, Tokyo (JP)

(72) Inventor: Nobuaki Suzuki, Akishima Tokyo (JP)

(21) Appl. No.: 14/967,239

(22) Filed: Dec. 11, 2015

(30) Foreign Application Priority Data
Jan. 28, 2015 (JP) 2015-014613

(51) Int. Cl. H04N 5/38; H04N 19/463; H04N 19/70; H04N 5/44

(52) U.S. Cl. CPC H04N 5/38; H04N 5/44; H04N 19/463; H04N 19/70

(57) ABSTRACT

A transmitting apparatus includes a transmitter. The transmitter is configured to add pixel data of a decoded video and additional data which is different from the pixel data to one transmission pixel. The transmitter is configured to transmit the one transmission pixel and size information to an external device. The size information indicates a size of an area occupied by the pixel data in the one transmission pixel.

### CROSS-REFERENCE TO RELATED APPLICATION

This application is based upon and claims the benefit of priority from Japanese Patent Application No. 2015-014613, filed on Jan. 28, 2015; the entire contents of which are incorporated herein by reference.

### FIELD

Embodiments of the present invention relate to a transmitting apparatus, a receiving apparatus, a transmitting method and a receiving method, which can efficiently transmit data.

### BACKGROUND

As an example of a multimedia interface between a video transmitting apparatus, such as a DVD player or a set-top box, and a video receiving apparatus, such as a TV set or a monitor, HDMI(Trademark) (High Definition Multimedia Interface) standard has been proposed. A device having a HDMI output terminal is referred to as a source device and a device having a HDMI input terminal is referred to as a sink device. The video transmitting apparatus is the source device and the video receiving apparatus is the sink device. Also, a device including a HDMI input terminal and a HDMI output terminal and having functions of both of the source device and sink device is referred to as a repeater device.

A HDMI communication device configured to perform communication in accordance with the HDMI standard as described above includes a TMDS (Transition Minimized Differential Signaling) transmitter for transmitting video, audio and auxiliary information; a +5V power supply signal transmitter for notifying a source ready state to a sink-side device when the source device is connected to the sink device or repeater device; a HPD signal transmitter for transmitting a HPD (Hot Plug Detect) signal to notify a sink ready state, which indicates that a preparation for receiving video information in the sink device or repeater device has been made, to the source-side device; and a EDID transmitter for transmitting EDID (Extended Display Identification Data) which is data such product information of the connected sink device, suitable video formats and the like. Also, depending on devices, a HDCP (High-bandwidth Digital Content Protection) certifying module for certifying the sink device and a CEC transmitter for transmitting CEC (Consumer Electronics Control), which is control-modification commands, are provided.

### BRIEF DESCRIPTION OF THE DRAWINGS

FIG. 1 is a view showing an example of an application of a transmitting apparatus and a receiving apparatus according to an embodiment.

FIG. 2 is a view showing an example of a system configuration of the transmitting apparatus and the receiving apparatus according to the embodiment.

FIG. 3 is a view showing an example of a system configuration for HDMI transmission in the transmitting apparatus and the receiving apparatus according to the embodiment.

FIG. 4 is a view showing an example of a video transmission timing format used in a communication apparatus of the embodiment.

FIGS. 5A, 5B and 5C are views showing an example of a pixel encoding format used in a communication apparatus of the embodiment.

FIGS. 6A, 6B and 6C are views showing an example of a data structure to be outputted from the transmitting apparatus and the receiving apparatus according to the embodiment.

FIG. 7 is a view showing a processing flow according to video transmission by the transmitting apparatus of the embodiment.

FIG. 8 is a view showing a processing flow according to video reception by the receiving apparatus of the embodiment.

### DETAILED DESCRIPTION

According to one embodiment, a transmitting apparatus includes a transmitter. The transmitter is configured to add pixel data of a decoded video and additional data which is different from the pixel data to one transmission pixel. The transmitter is configured to transmit the one transmission pixel and size information to an external device. The size information indicates a size of an area occupied by the pixel data in the one transmission pixel.

Embodiments will be now described with reference to the accompanying drawings.

Various embodiments will be described hereinafter with reference to the accompanying drawings.

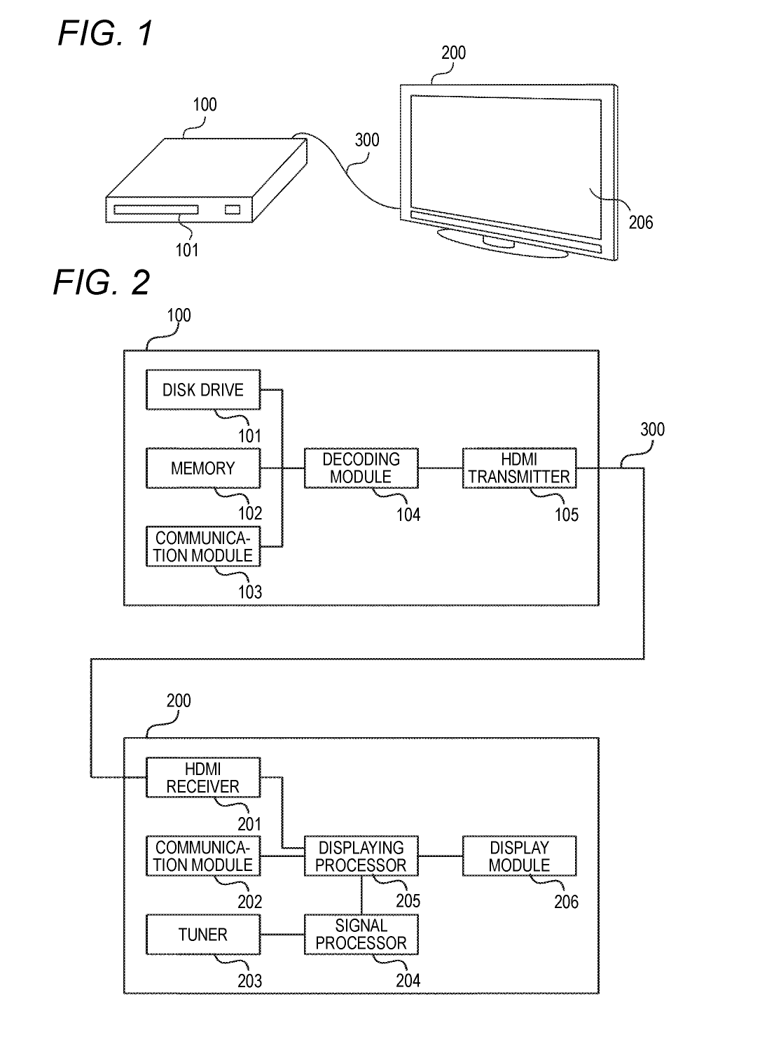

FIG. 1 is a schematic view showing an example of a data transmission system according to the first embodiment.

In the data transmission system, a reproduction device 100, which is a source device in the present embodiment, and a display device 200, which is a sink device, are connected to each other by a HDMI cable 300.

The reproduction device 100 has a disk drive 101 and is configured to reproduce (decode) coded video data stored in an optical disk or the like and to output the decoded video data to the display device 200 through the HDMI cable 300. The display device 200 has a display module 206 and is configured to display a video using the received video data.

FIG. 2 shows an example of hardware configurations of the reproduction device 100 and the display device 200.

The reproduction device 100 includes the disk drive 101, a memory 102, a communication module 103, a decoding module 104, and a HDMI transmitter 105. Each of such components 101 to 105 is embodied as a hardware circuit, and lines connecting the components in the figure represent electrical wrings, such as the dedicated lines or general-purpose communication buses on a board. Also, for example, partial functions, such as the decoder module 104, can be embodied by software, but even if such functions is embodied, the functions may be considered as being embodied by hardware circuits including a program storage memory and a CPU.

The disk drive 101 reads coded video data stored in the optical disk and then outputs the video data to the decoding module 104. Also, the memory 102 is a memory module, such as HDD or SSD, and is configured to store therein a prerecorded coded video data or coded video data received through a network. In addition, the memory 102 is configured to output the stored coded video data to the decoding module 104. The communication module 103 is a transceiver for a wireless LAN, a wired LAN, a mobile communication and the like, and is configured to acquire coded video data by communication. For example, the coded video data to be acquired is a corded video data published on internet public pages or coded video data provided by a server for VoD service. Namely, the communication module 103 acquires coded video data stored in external equipment. Also, the communication module 103 outputs the acquired coded video data to the decoding module 104.

The decoding module 104 decodes the coded video data (compressed video data) inputted thereto to generate a non-compressed video data. The decoding module may be a hardware decoder, or if the reproduction device 100 has a CPU, the CPU may be configured to read and run a decoding program from a memory. Also, formats of the video data obtained herein are various. For example, as color space formats, formats, such as RGB(RGB4:4:4), YCbCr4:4:4, YCbCr4:2:2, and YCrCb4:2:0, can be conceived. Also, if, in future, YCbCr4:1:1 is prescribed in the HDMI standard, the format may be used. As RGB formats, formats, such as 8 bit format, in which a data amount of each of R, G and B elements is 8 bit, 10 bit format, in which the data amount is 10 bit, 12 bit format, in which the data amount is 12 bit, and 16 bit format, in which the data amount is 16 bit, are included. As YCbCr4:4:4, YCbCr4:2:2 and YCrCb4:2:0 formats, formats, such as 8 bit format, in which a data amount of each of Y, Cb and Cr elements is 8 bit, 10 bit format, in which the data amount is 10 bit, 12 bit format, in which the data amount is 12 bit, and 16 bit format, in which the data amount is 16 bit, are included. As resolution formats, 640×480, 1280×720, 1980×1080, 3840×2160, 4096×2160, 7680×4320 and the like can be conceived and as frame rate formats, 30 Hz, 50 Hz, 60 Hz and the like can be conceived. Also, the decoding module 104 outputs the generated video data to the HDMI transmitter 105.

The HDMI transmitter 105 converts the video data inputted from the decoding module 104 to a video signal of a predetermined transmission format and then outputs the video signal to the display device 200 through the HDMI cable 300.

The display device 200 includes a HDM receiver 201, a communication module 202, a tuner 203, a signal processor 204, a displaying processor 205 and a display module 206. The HDMI receiver 201 receives the video signal from the reproduction device 100, converts the video signal to a video data of a format, which is capable of being processed by the displaying processor 205, and then outputs the video data to the displaying processor 205. The communication module 202 is a transceiver for a wireless LAN, a wired LAN, a mobile communication and the like, and is configured to acquire coded video data by communication. For example, the coded video data to be acquired is a corded video data published on internet public pages or coded video data provided by a server for VoD service. Also, the communication module 202 is configured so that the acquired coded video data is decoded by a decoding module, not shown, and the decoded video is outputted to the displaying processor 205.

The tuner 203 is configured to receive a broadcasting signal of television broadcasts. The signal processor 204 processes and converts the received broadcasting signal to a video data and then outputs the video data to the displaying processor 205. The displaying processor 205 converts the video data inputted from the HDMI receiver 201 and signal processor 204 to a video signal of a format, which is capable of being displayed by the display module 206, and then outputs the video signal to the display module 206. The display module 206 displays a video using the inputted video signal.

Also, the displaying processor 205 may include a selector to select one video from videos received by the HDMI ereceiver 201, communication module 202 and tuner 203 depending on operations of a user and then to output the selected video to the display module 206. Alternatively, the selector may be configured to select a plurality of videos depending on an operation of the user and thus to allow the plurality of videos to be displayed as a so-called multi-screen display on the display module 206. At this time, such operations of the user section select a video, for example, depending on operations of a remote controller. Alternatively, an operation signal in accordance with operations of the user on a remote controller application installed in a smart phone or tablet, not shown, may be received by the communication module 202 via a wireless/wired LAN and then, the selector may selects a video depending on the operation signal.

Also, the displaying processor 205 may be configured to output a video data, which is identical to a video data to be outputted to the display module 206, to the communication module 202. In this case, the communication module 202 transmits the inputted video data to the external device. In addition, the displaying processor 205 may be configured so that the video data is outputted to and encoded by an encoding module, not shown, and the communication module 202 may be configured to transmit the encoded video to the external device.

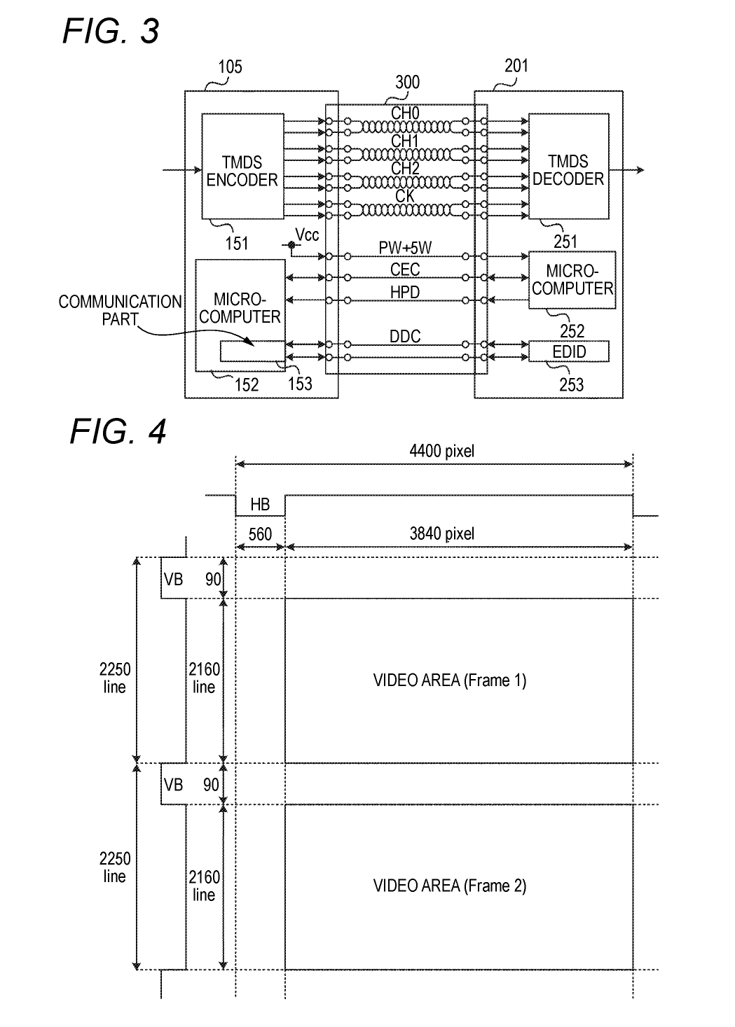

FIG. 3 is a view showing system configurations of the HDMI transmitter 105 of the reproduction device 100 and the HDMI receiver 201 of the display device 200.

The HDMI transmitter 105 includes a TMDS encoder 151, a microcomputer 152, a communication part 153 and the like. Also, the HDMI receiver 201 includes a TMDS decoder 251, a microcomputer 252, an EDID storage memory 253 and the like.

To the TMDS encoder 151, a video data of a format, such as RGB, YCbCr4:4:4, YCbCr4:2:2, YCbCr4:2:0 and YCbCr4:1:1 is inputted. Then, the TMDS encoder 2151 uses the inputted video data to generate data, in which the video data is arranged at a predetermined position. Also, the TMDS encoder 151 encodes the video data to a predetermined pixel encoding format. Further, the TMDS encoder 151 outputs the generated data to each of a channel 1 (CH1), channel 2 (CH2) and channel 3 (CH3) of a HDMI interface. In addition, differential amplifiers, not shown, convert the data outputted from the TMDS encoder 151 to differential signals and then outputs the differential signals to transmission lines of channels 0 to 2. The differential amplifiers are provided to correspond to each of the transmission lines of channels 0 to 2. Also, the differential signals are transmitted to the HDMI receiver 201 via the transmission lines of channels 0 to 2. Further, the differential amplifiers output a TMDS clock to a clock channel (CK). In addition, the TMDS decoder 251 outputs a pixel data of the video at a timing synchronized with the TMDS clock.

The HDM receiver 201 is provided with a differential amplifier (not shown) for each of channels 0 to 2. The differential amplifiers receives differential signals from the channels 0 to 2 to convert the differential signals to data and then to output the data to the TMDS decoder 251. Also, the TMDS decoder 251 decodes and then outputs the data to the displaying processor 205.

The microcomputer 152 of the reproduction device 100 is connected to the microcomputer 252 of the sink device via a CEC (Consumer Electronics Control) line and a HPD (Hot Plug Detect) line. The microcomputer 152 and the microcomputer 252 transmit information for mutually controlling between the devices to each other via the CEC line. Also, the microcomputer 252 receives a notification of turning on the HDMI transmitter 105 via a PW+5V line, and then if a preparation for receiving HDMI signals in the HDMI receiver 201 is completed, notifies the effect of signal transmitting preparation completion to the HDMI transmitter 105 via the HPD line.

The communication part 153 of the microcomputer 152 is connected to the EDID (Extended Display Identification Data) storage memory 253 of the sink device via a DDC line. Also, the communication part 153 reads EDID data from the EDID storage memory 253.

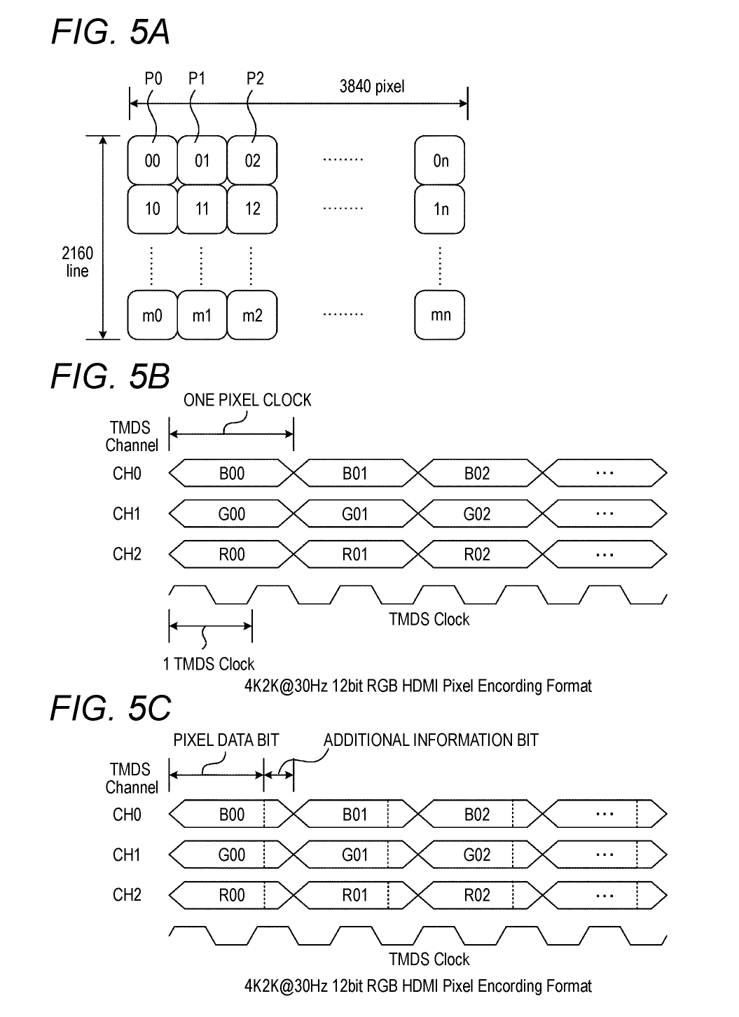

FIG. 4 shows an example of a data array in the data received by the HDMI receiver 201. Herein, an example when a video having horizontal and vertical pixel numbers of 3840×2160 is transmitted is shown. The HDMI transmitter 105 transmits data including video areas and blanking areas. In the video areas, video data (pixel data) of a pixel encoding format described below with respect to FIG. 5 is arranged. Also, as described below, additional information is further arranged in the video area. In a vertical blanking area VB (Vertical Blanking) and a horizontal blanking area HB (Horizontal Blanking), information for controlling the display device 200, audio data, InfoFrame, which are intended to notify formats of the transmitted video, and the like are arranged.

FIG. 5A is a view in which conceptual numbers are imparted to each pixel of one video frame. This is an example of descriptions in FIGS. 5 B and C.

FIG. 5B shows an example of a pixel encoding format for transmitting a video of RGB4:4:4. In the video areas of FIG. 4, pixel data of the video are encoded in accordance with such a pixel encoding format. In this format, one pixel clock is transmitted in one channel at every one and half TMDS clocks (1.5 cycles). Initial pixel clocks in the channels 1 to 3 include information of R00, G00 and B00, which are RGB elements of a pixel P0. Similarly, the next pixel clocks include elements R01, G01 and B01 of a pixel P1.

In data areas of pixel clocks of this example, 12 bit information can be encoded and thus 36 bit/pixel clock information is transmitted through three channels. Also, a bit length (bit numbers) of one pixel clock is not limited thereto, but for example, the bit length is 8 bit/pixel clocks (24 bits/pixel clock in three channels) if one pixel clock is transmitted at every one TMDS clock (1 cycle) and 16 bit/pixel clock (48 bits/pixel clock in three channels) if one pixel clock is transmitted at every two TMDS clocks (2 cycles). Namely, the HDMI transmitter 105 can change an amount of information to be transmitted per one pixel clock by changing a clock speed (clock frequency) of the TMDS clock. Also, information indicating a bit length (size) of data areas per one pixel clock is included, for example, InfoFrame.

Also, even if a bit length of pixel data per one pixel clock is increased, the number of pixels to be transmitted by one pixel clock is not changed. For example, when a video of RGB4:4:4 format is transmitted at 16 bits/pixel clock, not 12 bits/pixel clock, the number of RGB elements to be transmitted per one pixel clock is similar to those of the example of FIG. 5B. Namely, even in the case of 16 bits/pixel clock, information of R00, G00 and B00 is encoded in the initial pixel clocks and information of elements R01, G01 and B01 of a pixel P1 is encoded in the next pixel clocks.

Also, although RGB4:4:4 format is shown in FIG. 5B, pixel data to be transmitted per one pixel clock in other formats are the same as, for example, those in FIGS. 11 and 12 of JP-A-2005-514873. In YCbCr4:4:4, pixel data for one pixel is transmitted by one pixel clock. Namely, at the first pixel clock, pixel data of the pixel P0 in FIG. 5A, i.e., Y00, Cb00 and Cr00 are transmitted, and at the second pixel clock, pixel data of the pixel P1 are transmitted. In YCbCr4:2:2, pixel data for two pixels are transmitted at two pixel clocks. In the first pixel clock, Y00 and Cb00 are transmitted and in the second pixel clock, Y01 and Cr00 are transmitted. Also, in the third pixel clock, Y02 and Cb02 are transmitted and in the fourth pixel clock, Y03 and Cr00 are transmitted. In addition, although YCbCr4:2:0 or YCbCr4:1:1 is not shown in JP-A-2005-514873, for example, it is thought that in each pixel clock, pixel data for two pixels, i.e., two Y elements and one Cb (or Cr) element are transmitted.

FIG. 5C shows an example of a pixel encoding format in which pixel data of an actual video and additional information are included in each pixel clock. Also, the format of FIG. 5C is similar to the format of FIG. 5B, except that pixel data and additional information are encoded in each pixel clock. In the pixel encoding format, a bit length of each pixel clock is 12 bits, but a bit length of R, G and B elements to be encoded in each pixel clock is 10 bits. Namely, in this case, a bit length of R, G and B elements of RGB4:4:4 video data to be outputted from the decoder module 104 is 10 bits. Also, the TMDS encoder 151 prepares and transmits 12 bits as a data area for transmitting a RGB4:4:4 format video, but encodes only 10 bits as actual data (pixel data) of the RGB4:4:4 video to the data area. In the remaining area of 2 bits, the additional information is encoded. Also, in a leading head of the additional information, a specific bit pattern for indicating that the information is additional information may be included. Also, the bit pattern may be conceived as a bit pattern which is embedded in a boundary between pixel data bits and additional information bits to indicate the boundary.

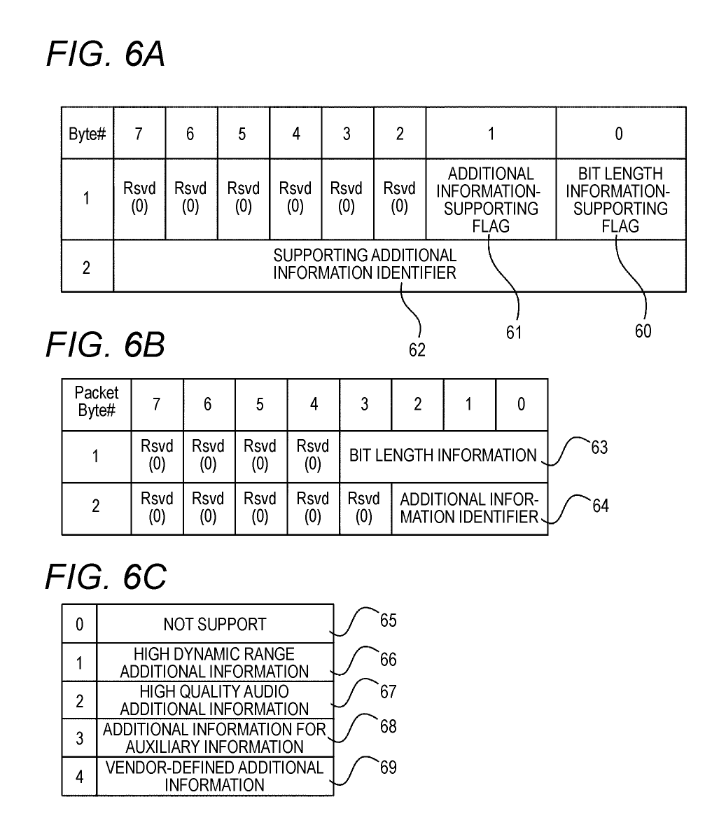

Also, the TMDS encoder 151 adds information, which indicates a bit length of an actual data (pixel data) to be encoded in the storage area of each pixel clock, to the transmitted data, but this will be described with respect to FIG. 6. Also, as examples of the additional information, HDR additional information used in high dynamic range processing for enhancing a contrast ratio of the video and the like, audio additional information used in enhancing a quality of audio, vendor-defined additional information autonomously defined by each vendor, size information (additional information for auxiliary information), which is not contained in the blanking areas, of auxiliary information (information for controlling the display device 200 or audio data) encoded in the blanking areas described above with respect to FIG. 4 and the like can be listed.

Also, although the RGB4:4:4 format has been illustrated in the description with respect to FIG. 5B and C, the description can be applied to YCbCr4:4:4, YCbCr4:2:2, YCbCr4:2:0 and YCbCr4:1:1 formats. For example, in respect of YCbCr4:2:2, coding methods such as HEVC defines Main 10 profile of 10 bit colors, but if the method of the present embodiment is used, video data of YCbCr4:2:2 10 bits/Y element and 10 bits/CbCr elements obtained by decoding the coded data can be transmitted, for example, at 8 bits/pixel clock. channel. If Y element of 8 bits is encoded in the pixel clock of the channel 1, Cb/Cr element of 8 bits is encoded in the pixel clock of the channel 2 and Y element of 2 bits and Cb/Cr element of 2 bits are encoded in the pixel clock of the channel 0, a free area of 4 bits is occurred in the pixel clock and thus additional information of 4 bits per one pixel clock. three channel can be transmitted. In this case, the HDMI transmitter 105 notifies to the HDMI receiver 201 the effect that pixel data having an actual video data length (actual pixel data length) of 10 bits are transmitted in the YCbCr4:2:2 format. If transmission of 8 bits/pixel clock. channel is previously set in the HDMI transmitter 105 and the HDMI receiver 201 as defaults for transmission of the YCbCr4:2:2 format, the HDMI transmitter 105 may not explicitly notify (but, preferably notify) to the HDMI receiver 201 the effect that transmission is performed at 8 bits/pixel clock. channel. On the basis of this notification, the HDMI receiver 201 extracts Y element of 8 bits from the channel 1, extracts Cb/Cr element of 8 bits from the channel 2, and extracts Y element of 2 bits, Cb/Cr element of 2 bits and additional information of 4 bits from the channel 0.

The description with respect to FIG. 5 can be stated in another way as follows. In the HDMI standard, transmission using a pixel encoding format, in which each pixel data (pixel clock) having a predetermined module is encoded in a data area having a predetermined bit length (data area for each pixel clock) is prescribed. Namely, in the example of RGB4:4:4 in FIG. 5C, a pixel encoding format in which one R element, one G element and one B element as the predetermined module are encoded in data areas having a predetermined bit length (12 bits/one pixel clock. channel) is used. Also, in YCbCr4:4:4, one Y element, one Cb element and one C element are the predetermined module. In YCbCr4:2:2, one Y element and one Cb element (or one Cr element) are the predetermined module. In YCbCr4:2:0 and YCbCr4:1:1, two Y elements and one Cb element (or one Cr element) are the predetermined module. In addition, the HDMI transmitter 105 can add information, which indicates a color space format of pixel data to be transmitted, for example, to InfoFrame and thus and transmit the information, thereby notifying the color space format to the HDMI receiver 201.

Also, although the bit length of the data areas can be changed by adjusting the HDMI transmitter 105 and the HDMI receiver 201 upon transmission, this is the same as described above. The HDMI transmitter 105 may add information, which indicates a bit length of data areas, to InfoFrame and thus transmit the information, thereby notifying the bit length of data areas to the HDMI receiver 201. Alternatively, because the bit length of data areas and the TMDS clock speed (frequency) are proportional to each other, the HDMI receiver 201 may recognize the bit length of data areas based on the TMDS clock speed. Alternatively, when information indicating the bit length of data areas is not added to InfoFrame, the HDMI receiver 201 may recognize that the bit length of data area is a predetermined normal bit length.

Also, the HDMI transmitter 105 of the present embodiment is configured to encode the actual pixel data and also the additional information (2 bits/one channel in the example of FIG. 5C) in each data area using the pixel encoding format in which the data areas have a bit length (12 bits/one pixel clock. channel in the example of FIG. 5C) larger than an actual bit length (10 bits for each of R, G and B elements in the example of FIG. 5C) of pixel data having the predetermined module. Also, the HDMI transmitter 105 transmits information indicating a bit length of each element of pixel data (R element, G element and B element in the example of FIG. 5C) to the HDMI receiver 201.

FIG. 6 shows an example of EDID and InfoFrame used in the present embodiment. FIG. 6A is a data structure example of EDID.

A bit length information-supporting flag 60 is stored in 0^{th} bit of bite 1. The flag 60 indicates whether or not the display device 200 or HDMI receiver 201 supports bit length information 63 (described below) transmitted from the HDMI transmitter 105. When the flag indicates “support”, the display device 200 or HDMI receiver 201 can interpret the bit length information 63 transmitted from the HDMI transmitter 105, recognize a bit length of pixel data bits encoded in each pixel clock (bit length) and then extract and decode the supporting bits from each pixel clock as pixel data. If the flag is “non-support”, the HDMI receiver 201 decodes all bits of each pixel clock as pixel data.

In 1^{st} bit of the bite 1, an additional information-supporting flag 61 is stored. The flag 61 indicates whether or not the display device 200 or HDMI receiver 201 supports additional information encoded in an additional information area in each pixel clock. When the flag 61 indicates “support”, i.e., when the flag 60 and flag 61 indicate “support”, the display device 200 or HDMI receiver 201 can recognize an area, in which additional information is encoded, of data areas of each pixel clock based on the bit length indicated by the bit length information 63 and then decode the additional information as additional information. If the flag 60 is “support” and the flag 61 is “non-support”, the HDMI receiver 201 does not decodes the additional information or decodes and then destroys the additional information.

In bite 2, a supporting additional information identifier 62 is stored. The identifier 62 indicates what type of addition information is supported by the display device 200 or HDMI receiver 201. As types of additional information, as described, HDR additional information, audio addition information, vendor-defined additional information, additional information for auxiliary information and the like can be included. Also, for example, identifiers of FIG. 6C are stored as the identifier 62. If an identifier 65 is stored as the identifier 62, the display device 200 or HDMI receiver 201 does not support additional information.

If an identifier 66 is stored as the identifier 62, the display device 200 or HDMI receiver 201 supports HDR additional information. Namely, in this case, when video data including HDR additional information is received, the HDMI receiver 201 decodes and outputs pixel data and HDR additional information to the displaying processor 205, and the displaying processor 205 uses the pixel data and HDR additional information inputted thereto to produce a video having a higher contrast ratio than a case where the additional information is not used.

If an identifier 67 is stored as the identifier 62, the display device 200 or HDMI receiver 201 supports audio additional information. Namely, in this case, when video data including audio additional information is received, the HDMI receiver 201 decodes and outputs audio data and audio additional information in auxiliary information to an audio processor, not shown, and the audio processor produces a higher quality audio using the audio data and audio additional information inputted thereto.

Similarly, if an identifier 68 is stored as the identifier 62, the display device 200 or HDMI receiver 201 supports additional information for auxiliary information, and if an identifier 69 is stored as the identifier 62, the display device 200 or HDMI receiver 201 supports vendor-defined additional information

FIG. 6B shows a data structure example of InfoFrame transmitted by the HDMI transmitter 105. In 0^{th} to 3^{rd} bits of the bite 1, the bit length information 63 is encoded. The information 63 indicates the bit length of pixel data bits described with respect to FIG. 5C. Namely, when data is transmitted in the format of FIG. 5C, information indicating 10 bits is encoded in the information 63. Also, in the bit length information 63, information indicating a bit length of additional information bits may be encoded, not the bit length of pixel data bits. Also, in the bit length information 63, both of information indicating the bit length of pixel data bits and information indicating the bit length of additional information bits may be encoded.

In 0^{th} to 2^{nd} bits of bite 2, an additional information identifier 64 is encoded. The identifier 64 indicates types of information encoded in the additional information bits shown in FIG. 5C. For example, identifiers 65 to 69 of FIG. 6C are encoded as the identifier 64. If the HDMI transmitter 105 does not encode significant information in additional information bits, the identifier 65 as the identifier 64 is encoded in InfoFrame. In this case, the additional information bits are padded into, for example, 0. If the HDMI transmitter 105 encodes HDR additional information in the additional information bits, the identifier 66 as the identifier 64 is encoded in InfoFrame. If the HDMI transmitter 105 encodes audio additional information in the additional information bits, the identifier 67 as the identifier 64 is encoded in InfoFrame. If the HDMI transmitter 105 encodes additional information for auxiliary information in the additional information bits, the identifier 68 as the identifier 64 is encoded in InfoFrame. If the HDMI transmitter 105 encodes vendor-defined additional information in the additional information bits, the identifier 69 as the identifier 64 is encoded in InfoFrame. Also, in InfoFrame, information indicating a color space formation of a video to be transmitted and information indicating a size (bit length) of data area of each pixel clock are encoded. For example, in the case of data transmission by the pixel encoding format of FIG. 5C, information indicating the effect that the format is the RGB4:4:4 format and the effect that a bit length of each pixel clock is 12 bits is encoded in InfoFrame. For example, in the case of data transmission by the pixel encoding format of FIG. 5C, the effect that the format is RGB4:4:4 format and the effect that the bit length of each pixel clock is 12 bits are encoded in InfoFrame. Also, not the bit length of pixel clock per one channel but a total bit length of three channels may be encoded in InfoFrame. In this case, the effect that the bit length is 36 bits is encoded in InfoFrame. Also, information indicating the bit length of each pixel clock may be not encoded. In this case, if there is no information, the rule that the data area of each pixel clock is for example 10 bits is previously shared and set to the reproduction device 100 and the display device 200.

Also, although examples in which the flag 60, flag 61 and flag 62 are stored in EDID are shown in FIG. 6A, the flag 61 and flag 62 may be omitted and thus only the flag 60 may be stored in EDID. Similarly, the additional information identifier 64 of InfoFrame may be omitted. In this case, “valid” of the flag 60 is defined as indicating the effect that additional information is supported and HDR additional information is supported as well as the effect that the bit length information is supported, and thus if a valid value with respect to the bit length information 63 is encoded in InfoFrame, it may be defined that additional information to be transmitted is HDR addition information. Also, this definition is previously shared and set to the reproduction device 100 and the display device 200. As a timing at which setting is performed, timings, such as factory shipping, firmware updating, user setting or the like, can be included, but setting has to be previously performed at at least a timing prior to transmission of a video. Also, although it is herein described that “valid” of the flag 60 indicates that HDR additional information is supported and the bit length information 63 indicates that HDR additional information is transmitted, the flag 60 and the information 63 may indicate other additional information of FIG. 6C.

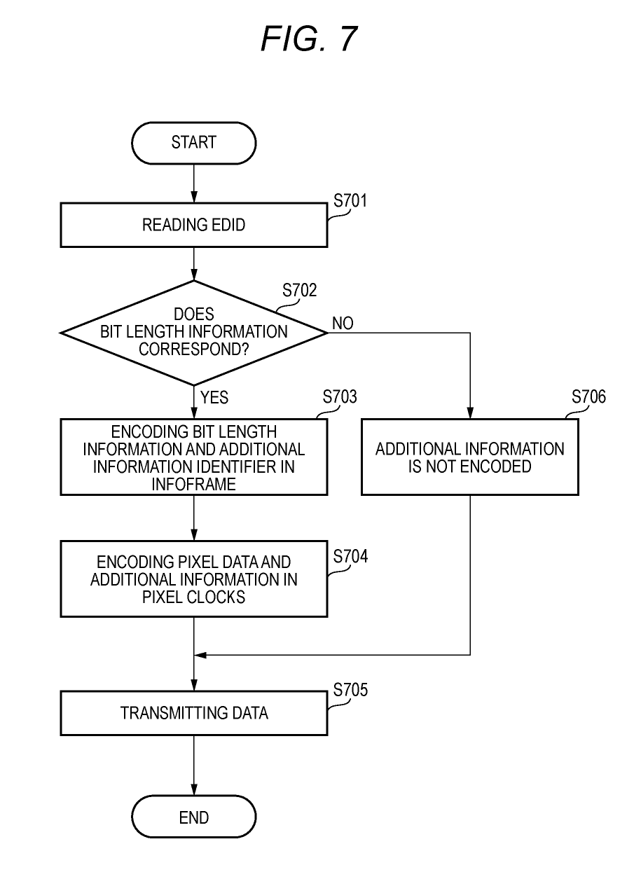

FIG. 7 shows an example of a processing flow by the reproduction device 100. First, the HDMI transmitter 105 reads EDID and identifies the bit length information-supporting flag 60 of FIG. 6A (S701). Then, when the flag 60 indicates “support” (S702), the HDMI transmitter 105 encodes the bit length information 63 and the additional information identifier 64 to InfoFrame as in FIG. 6B (S703) and encodes pixel data and additional information to data areas of pixel clocks as in FIG. 5C (S704). Also, as described with respect to FIG. 6, when additional information to be transmitted is previously specified in the HDMI transmitter 105 and the HDMI receiver 201, the additional information identifier may be omitted. Then, the HDMI transmitter 105 arranges InfoFrame in the blanking areas of FIG. 4, arranges pixel clock data including pixel data and additional information in the video areas of FIG. 4, and then outputs the data (S704). On the other hand, when in S702, the flag 60 indicates “non-support”, the HDMI transmitter 105 outputs, for example, data in which additional information is not included in areas corresponding to the additional information bits of FIG. 5 (S706, S705).

Also, in FIG. 7, a processing example in the case where reading and processing of the additional information-supporting flag 61 and the supporting additional information identifier 62 are omitted is described. When the additional information-supporting flag 61 is used in the HDMI transmitter 105 and the HDMIreceiver 201, the HDMI transmitter 105 additionally identifies the additional information-supporting flag 61 after S702 is Yes and then if the flag 61 indicates “support”, performs processing of S703, but if indicating “non-support”, outputs data in which additional information is not added to each pixel clock but the bit length information 63 is added to InfoFrame. Also, when the supporting additional information identifier 62 is used in the HDMI transmitter 105 and the HDMI receiver 201, the HDMI transmitter 105 additionally identifies the supporting additional information identifier 62 after S702 is Yes, and then adds additional information supported by the HDMI receiver 201 in S704.

Also, the HDMI transmitter 105 may change a bit length per pixel clock depending on identification results of S702. Namely, for example, in respect of the case where a bit length of a video to be transmitted is 10 bits, the HDMI transmitter 105 may output data including additional information of 2 bits or 6 bits using a pixel encoding format having a bit length per pixel clock of 12 bits or 16 bits if S702 is Yes, but may output data, which have no space in pixel clocks, using a pixel encoding format having pixel clocks of 10 bits if S702 is No.

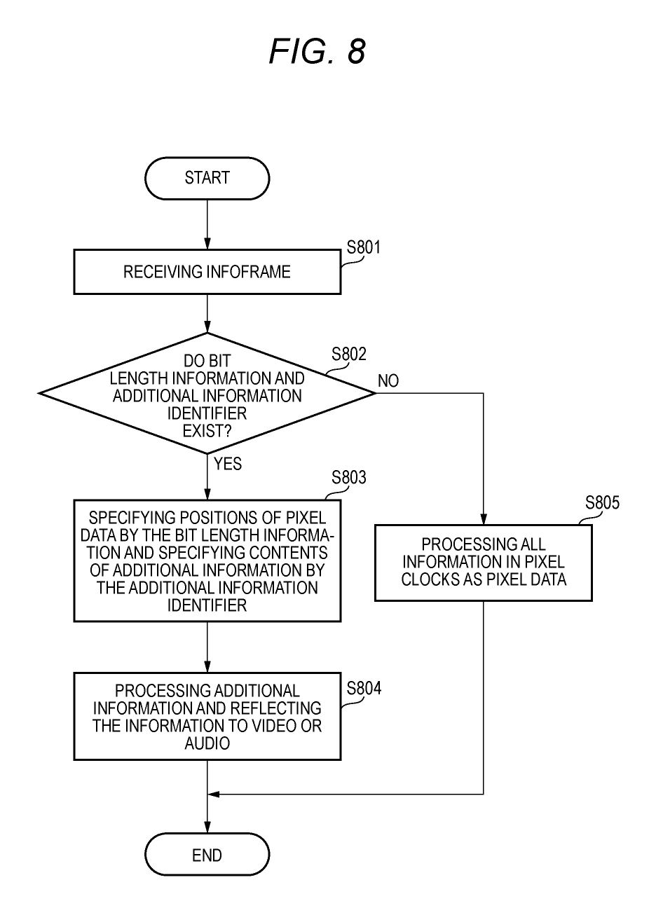

FIG. 8 shows an example of a processing flow in the display device 200. First, the HDMI receiver 201 sets the bit length information-supporting flag 60 to “support” if the bit length information 63 is supported by its own device, sets the additional information-supporting flag 61 to “valid” if additional information is supported, and also stores information of additional information, which is supported by its own device, to the supporting additional information identifier 62. Also, when the HDMI transmitter 105 reads EDID in which such information is stored and the HDMI receiver 201 receives data transmitted in accordance with the EDID, the HDMI receiver 201 first receives and interprets InfoFrame (S801). If bit length information and an additional information identifier are included in InfoFrame (S802 is Yes), the HDMI receiver 201 specifies positions of pixel data in each pixel clock based on the bit length information and also specifies contents of additional information based on the additional information identifier (S803). Also, as described above with respect to FIG. 6, when additional information to be transmitted is previously specified in the HDMI transmitter 105 and the HDMI receiver 201, the additional information identifier may be omitted, and in this case, the HDMI receiver 201 performs processing of S802 or S805 depending on whether or not the bit length information exists.

For example, in respect of processing of S803, when a size of data areas of pixel clocks is 12 bits and the bit length information indicates, for example, 10 bits, the HDMI receiver 201 specifies MSB 10 bits of each pixel clock as pixel data and also specifies MLB 2 bits as additional information.

Then, the HDMI receiver 201 extracts and decodes the pixel data and the additional information, and the HDMI receiver 201 and/or other modules process a video, audio and the like using data obtained by decoding (S804). For example, if the additional information is HDR addition information, the displaying processor 205 creates a high contrast video using the decoded pixel data and the decoded HDR additional information.

On the other hand, if the bit length information and the additional information identifier do not exist in InfoFrame (S802 is No), the HDMI receiver 201 process, as pixel data, all information encoded in the data areas of pixel clocks arranged in the video areas of FIG. 4 (S805).

Also, although a case where a specific bit pattern is not included in additional information is described in the flow of FIG. 8, if the specific bit pattern is included in the additional information, the HDMI receiver 201 may specify areas, which follow the bit pattern, of data areas of each pixel clock as additional information bits and also specify areas preceding the bits as pixel data, thereby extracting the pixel data and the additional information. Also, even if the specific bit pattern is included in the additional information, the HDMI receiver 201 may specifies additional information bits based on the bit length information included in InfoFrame. Namely, in a case where the display device 200 is a device which takes time until interpretation results are received and processed after interpretation of InfoFrame. The HDMI receiver 201 specifies the additional information bits based on the bit pattern until the interpretation results of InfoFrame are reflected and then specifies the additional information bits based on the bit length information after the interpretation results of InfoFrame have been reflected.

Although transmission in HDMI is mainly described in the foregoing embodiments, the method of the present embodiments can be applied to standards in which video data obtained by decoding of coded video data, such as RGB:4:4:4, YCbCr4:4:4, YCbCr4:2:2, YCbCr4:2:0 and YCbCr4:1:1 are transmitted. Namely, the method of the present embodiment can be applied, for example, to MHL standard, Display Port standard and other transmission standards, in which a video is transmitted in a non-compression manner.

Although a number of embodiments of the preset invention are described, the embodiments are proposed as examples and thus not intended to limit the scope of the invention. These novel embodiments can be embodied as other various modes and also various omissions, replacements and modifications thereof can be made without departing from the spirit of the invention. The embodiments and variants thereof are encompassed in the scope and spirit of the invention and also encompassed in the scope equivalent to the inventions set forth in the appending claims.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transmitting apparatus comprising:
a transmitter,
wherein the transmitter is configured to add pixel data of a decoded video and additional data which is different from the pixel data to one transmission pixel and configured to transmit the one transmission pixel and size information to an external device, the size information indicating a size of an area occupied by the pixel data in the one transmission pixel.

2. The transmitting apparatus according to claim 1,
wherein the transmitter is configured to transmit identification information to the external device, the identification information indicating a content of the additional data.

3. The transmitting apparatus according to claim 1,
wherein the transmitter is configured to transmit the transmission pixel and the size information to the external device via an interface in accordance with a predetermined standard;
wherein the predetermined standard is defined so that the pixel data is encoded in the one transmission pixel at a predetermined bit length thereof; and
wherein a bit length of information capable of being encoded in the one transmission pixel is more than the predetermined bit length.

4. The transmitting apparatus according to claim 1,
wherein the transmitter is configured to transmit transmission clocks at predetermine cycles and to transmit the one transmission pixel corresponding to a predetermined number of transmission clocks.

5. A receiving apparatus comprising:
a receiver configured to receive one transmission pixel and size information,
wherein the one transmission pixel includes pixel data of a decoded video and additional data which is different from the pixel data, and
the size information indicates a size of an area occupied by the pixel data in the one transmission pixel, and
an extracting module configured to extract the pixel data and the additional data by specifying positions of the pixel data in the one transmission pixel based on the size indicated by the size information.

6. The receiving apparatus according to claim 5, further comprising:
a transmitter configured to output information indicating whether or not a format in which the pixel data and the additional data is included in the one transmission pixel is supported.

7. The receiving apparatus according to claim 6,
wherein the transmitter is configured to output information indicating a type of additional information supported by the receiving apparatus.

8. The receiving apparatus according to claim 6,
wherein the transmitter is configured to output information stored in an EDID memory.

9. The receiving apparatus according to claim 5,
wherein the receiver is configured to receive the transmission pixel and the size information from a transmitting apparatus via an interface in accordance with a predetermined standard;
wherein the predetermined standard is defined so that the pixel data is encoded in the one transmission pixel at a predetermined bit length thereof; and
wherein a bit length of information capable of being encoded in the one transmission pixel is more than the predetermined bit length.

10. The receiving apparatus according to claim 5,
wherein the receiver is configured to receive transmission clocks from a transmitting apparatus at predetermine intervals and to transmit the one transmission pixel transmitted from the transmitting apparatus corresponding to a predetermined number of transmission clocks.

11. A transmitting method in a transmitting apparatus, comprising:
adding pixel data of a decoded video and additional data which is different from the pixel data to one transmission pixel, and transmitting the one transmission pixel and size information to an external device, the size information indicating a size of an area occupied by the pixel data in the one transmission pixel.

12. A receiving method in a receiving apparatus, comprising:
receiving one transmission pixel and size information,
wherein the one transmission pixel includes pixel data of a decoded video and additional data which is different from the pixel data,
the size information indicates a size of an area occupied by the pixel data in the one transmission pixel; and
extracting the pixel data and the additional data by specifying positions of the pixel data in the one transmission pixel based on the size indicated by the size information.
